(19) United States
(12) Patent Application Publication
(10) Pub. No.: US 2022/0261735 A1
(43) Pub. Date: Aug. 18, 2022

(54) System and Method of Determining Personalized Productivity Goals and Monitoring Productivity Behaviors of an Individual Towards the Productivity Goals

(71) Applicant: Vitality Group International, Inc., Chicago, IL (US)

(72) Inventors: Daniel Kotzen, New York, NY (US); Stephanus Francois Millard, Chicago, IL (US); Stephen Ronald Mitchley, Darien, CT (US)

(73) Assignee: Vitality Group International, Inc., Chicago, IL (US)

(21) Appl. No.: 17/734,526

(22) Filed: May 2, 2022

Related U.S. Application Data
(63) Continuation of application No. PCT/IB2020/060266, filed on Nov. 2, 2020.
(60) Provisional application No. 62/929,354, filed on Nov. 1, 2019.

(51) Int. Cl. G06Q 10/06

(52) U.S. Cl. CPC G06Q 10/063118; G06Q 10/063114

(57) ABSTRACT

A system and method for determining personalized productivity goals and monitoring workplace behaviors of an individual towards the productivity goals is provided. The method includes storing user data including a user identifier and other data relating to the user, at least one software utility account identifier each identifying a software utility account associated with the user, and at least one device identifier each identifying a device associated with the user. The user data is processed to determine personalized productivity goals for the user. The system receives software utility account data from one or more software utility accounts associated with the user, and device data from at least one device associated with the user and uses the received software utility account data and device data to monitor workplace behaviors of an individual towards the personalized productivity goals.

### FIELD OF THE INVENTION

The present application relates to a system and a method of determining personalized productivity goals and monitoring workplace behaviors of an individual towards the productivity goals.

### BACKGROUND OF THE INVENTION

People have a wealth of technology at their disposal to maximize their productive workplace behaviors, but are often unaware of the behavioral missteps and misuse of these tools that cost them and their organizations valuable time. This mismanagement of time often leads to an erosion of work-life balance as inefficient workplace behaviors leads to less focused work time during the work day, which often necessitates after-hour work. The erosion of work-life balance is associated with higher rates of health-related absenteeism, generating an impaired workforce and a material economic burden.

### SUMMARY OF THE INVENTION

The system and method for determining personalized productivity goals, monitoring workplace behaviors of an individual towards the productivity goals, and providing a propriety score to the individual and in the aggregate to the funder of the system for the individuals is provided to address this.

One aspect of the invention relates to a system for determining personalized productivity goals and monitoring workplace behaviors of an individual towards the personalized productivity goals using an AI/ML (artificial intelligence/machine learning) model. The system includes:

a memory for storing data therein, the data including user data including a user identifier and other data relating to the user, at least one software utility account identifier each identifying a software utility account associated with the user, and at least one device identifier each identifying a device associated with the user;

a communications module for transmitting and receiving data; and

at least one processor operably coupled to the memory and the communications module.

The at least one processor controls the system to access the stored data and to process the data to:

retrieve the user data and use the user data to determine personalized productivity goals for the user;

receive, via the communications module, software utility account data from one or more software utility accounts associated with the user, and device data from at least one device associated with the user;

create a first training set for a first stage comprising a user's unique organizational context, a user's survey responses, a user's historical goal achievement, and other data sources;

train the AI/ML model in the first stage using the first training set for productivity goal detection;

create a second training set for a second stage comprising false positives, produced after productivity goal detection has been performed on a set of user's responses on whether a goal is useful, and pairing the user's responses with a user's actual behavior data by using the received software utility account data and device data to monitor workplace behaviors of an individual towards the personalized productivity goals; and train the AI/ML model in the second stage using the second training set for productivity goal detection.

The software utility accounts can include one or more of e-mail, a calendar and software collaboration tools. The device associated with the user can include one or more of a laptop computer, a desktop computer, a mobile telephone, a tablet device and a wearable device. In an embodiment, the wearable device includes a heart rate monitor.

The received device data can include location data identifying a location of the device. The received device data can include activity data including user activity on the device. The received software utility account data can include data about the user's interaction with the software utilities including the user's interactions and associations with other users.

The system can further include a content module that generates and manages a delivery of content to system users. The system can further include a survey module that generates surveys to determine productivity and workplace information. The system can further include a data lake and machine learning module to determine a relationship between positive improvements in productivity measures and survey results and a broader range of data collected. The system can further include a scoring module that determines and retains a history of the user's productivity score.

The personalized productivity goals can be determined by applying a goal generation algorithm to data collected for the individual. The communication module can manage authentication between the system and external data sources.

Another aspect of the invention relates to a method for determining personalized productivity goals and monitoring workplace behaviors of an individual towards the personalized productivity goals using an AI/ML model. The method includes:

storing data in a memory, the data including user data including a user identifier and other data relating to the user, at least one software utility account identifier each identifying a software utility account associated with the user, and at least one device identifier each identifying a device associated with the user; and

processing the data by at least one processor operably coupled to the memory to:

retrieve the user data and use the user data to determine personalized productivity goals for the user;

receive, via a communications module, software utility account data from one or more software utility accounts associated with the user, and device data from at least one device associated with the user;

creating a first training set for a first stage comprising a user's unique organizational context, a user's survey responses, a user's historical goal achievement, and other data sources;

training the AI/ML model in the first stage using the first training set for productivity goal detection;

creating a second training set for a second stage comprising false positives, produced after productivity goal detection has been performed on a set of user's responses on whether a goal is useful, and pairing the user's responses with a user's actual behavior data by using the received software utility account data and device data to monitor workplace behaviors of an individual towards the personalized productivity goals; and

training the AI/ML model in the second stage using the second training set for productivity goal detection.

The software utility accounts can include one or more of e-mail, a calendar and software collaboration tools. The device associated with the user can include one or more of a laptop computer, a desktop computer, a mobile telephone, a tablet device and a wearable device. In an embodiment, the wearable device includes a heart rate monitor.

The received device data can include location data identifying a location of the device. The received device data can include activity data including user activity on the device. The received software utility account data can include data about the user's interaction with the software utilities including the user's interactions and associations with other users.

The personalized productivity goals can be determined by applying a goal generation algorithm to data collected for the individual. The user can be rewarded for a successful completion of goals.

### BRIEF DESCRIPTION OF THE DRAWINGS

FIG. 1 is a block diagram illustrating an example system to implement the methodologies described herein;

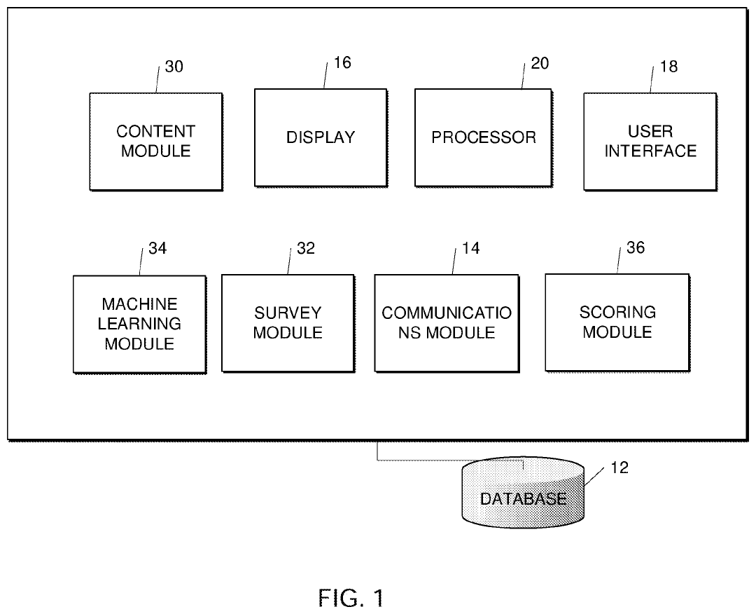

FIG. 2 shows a number of different user devices connecting into the system of FIG. 1; and

FIG. 3 is a flow diagram illustrating at a high level the operation of the method implemented by the system.

### DESCRIPTION OF THE EMBODIMENTS

The system and methodology described herein relate to a method of determining personalized productivity goals, monitoring workplace behaviors of an individual towards the productivity goals and deriving a proprietary workplace risk/efficacy score.

In one example embodiment, the modules described below may be implemented by a machine-readable medium embodying instructions which, when executed by a machine, cause the machine to perform any of the methods described above.

In another example embodiment the modules may be implemented using firmware programmed specifically to execute the method described herein.

It will be appreciated that embodiments of the present invention are not limited to such architecture, and could equally well find application in a distributed, or peer-to-peer, architecture system. Thus, the modules illustrated could be located on one or more servers operated by one or more institutions.

It will also be appreciated that in any of these cases the modules form a physical apparatus with physical modules specifically for executing the steps of the method described herein.

Referring to the accompanying figures, a computer implemented system 10 for determining personalized productivity goals and monitoring workplace behaviors of an individual towards the productivity goals is shown.

The system 10 includes a non-transitory data-storage memory 12, typically in the form of a database.

The data stored in the database 12 will typically include at least some of:
user data including a user identifier and other data relating to the user;
at least one software utility account identifier each identifying a software utility account associated with the user; and
at least one device identifier each identifying a device associated with the user.
   This use of this data will be described in more detail below.

Participants on the platform will be provided the ability to link to third party ecosystems on a consented basis through methods such API integration using techniques such as but not limited to O-auth 2 and SML, mobile platform linkages such as Googlefit and Healthkit. The platform will maintain these connection including any token refreshes or mobile background services to stream data signals to the platform on the members behalf.

A communications module 14 is used for transmitting and receiving data.

The server also typically includes a display 16 and a user interface 18 by means of which a user can input data to the server 10.

A processor 20 is operably coupled to the memory 12, communications module 14, display 16 and user interface 18 to control the operation of the system 10.

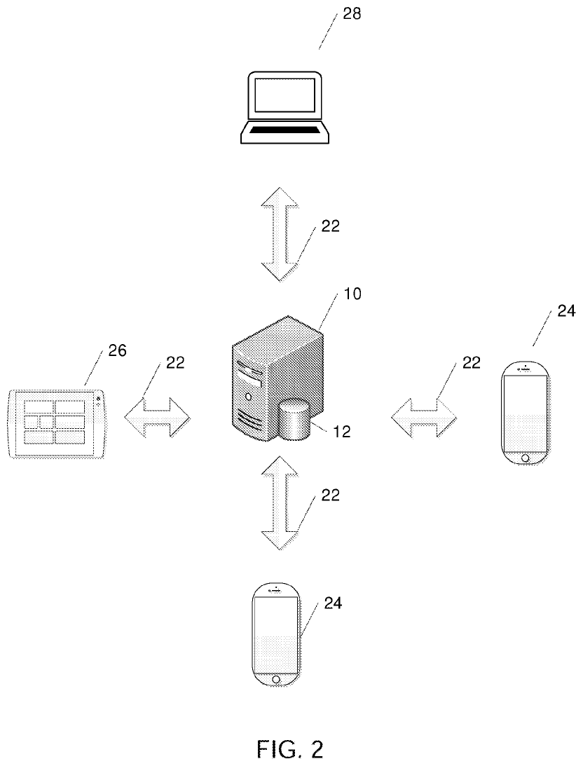

Referring to FIG. 2, a large number of users will access the system 10 via different communications networks 22.

These will include mobile communications networks, the Internet, and proprietary networks belonging to one or more organizations to name a few examples.

The users will use different devices including mobile telephones 24, tablets 26 and desktop or laptop computers 28.

The devices may also include a user wearable device (not shown) which detects the number of steps the user takes per day and the user's heart rate to name a few examples. Examples of such devices are a Fitbit™, Apple Watch™, Samsung Watch™ or Garmin Watch™, all of which are worn on a user's wrist.

It will be appreciated that each user will typically have more than one of these devices.

The communication module 14 manages authentication so that communication between the system and these devices as well as any other external data sources is authenticated.

As mentioned above, for each device, a device identifier identifying the device associated with the user is stored in the database 12.

Typically, some of the devices will be executing software utilities and stored in the database will be a software utility account identifier, each identifying a software utility account associated with the user.

The software utility accounts include one or more of e-mail, a calendar and software collaboration tools.

Thus, stored in the database in an associated fashion will be a list of users, an identification of their devices and an identification of their software utilities they are executing on these devices.

The system 10 will typically start with a survey which each user will complete using one of their devices and the answers of which will be transmitted to the system 10 and stored in the database 12 as part of the user data.

To this end the system includes a survey module 32 that is typically made up of hardware and software elements and may form part of the processor 14 or may be implemented separately therefrom but connected thereto as illustrated.

Users will complete the survey encompassing questions concerning their role in their organization and the typical characteristics of their day as it pertains to meeting volume, e-mail activity, focus time, collaboration, and managerial responsibilities, for example.

The system will source organizational structure and roles and store the user's relationship with fellow employees.

User data will initially be stored and combined with the survey data to determine personalized productivity goals for the user.

The combination of the user data, planned and reported meetings and the connectivity with other team members will be inputs into the goal generation.

The generation of individual productivity goals for the user will be based on those attributes that are deemed suboptimal relative to an individual's work responsibilities and profile.

The personalized productivity goals are determined by applying a goal generation algorithm to the data collected for the individual user.

Thus, the method includes generating personalized productivity goals by combining member profile data with individual workplace productivity data drawn from several software APIs.

These goals will be stored in the memory 12.

The system 10 will now receive via the communications module 14, software utility account data from one or more software utility accounts associated with the user, and device data from at least one device associated with the user.

The system 10 will use the received software utility account data and device data to monitor workplace behaviors of each user towards their personalized productivity goals.

The received software utility account data includes data about the user's interaction with the software utilities including the user's interactions and associations with other users.

Wearable and cellular device data is also sourced and combined with productivity data where appropriate.

In addition to assessing progress towards physical activity goals generated by the program, these devices will be utilized to assess activity during the work day.

Thus, device data will be received by the system 10 from one or more of the user devices which includes location data identifying a location of the device as well as activity data including user activity on the device.

In one example, meeting behavior will be mapped to cellular data usage of the user's mobile telephone 24 and device gyroscopic data also obtained from the user's mobile telephone 24 to assess whether the user in a meeting is potentially multi-tasking.

For instance, an individual who is found to be lifting their phone periodically during scheduled meeting time will be classified as multi-tasking.

In another example, use of apps or texting during meeting time will be classified as multi-tasking.

In another example, individuals with a wearable device found to be lifting their wrist periodically, and for sustained periods of time, will be classified as multi-tasking during a meeting.

This data will be stored as a new behavioral data attributes.

A history of the user's productivity score will also be stored in the memory 12.

As part of the present invention, individuals will periodically be asked to assess whether they were able to achieve everything they intended on a given day along with their perceived barriers to achieving their daily productivity goals. This data will be stored and utilized to calibrate the user personalized productivity profile and score.

Thus, for a given organizational role and context, a unique combination of lifestyle behaviors from the multiple data sources noted above, along with meetings, e-mails, and other workplace productivity measures will be mapped to an individual's self-perceived efficiency to calibrate the individual's personalized goal recommendations.

For instance, an individual in a client-facing role might deem a productive day to be comprised of many high-quality meetings whilst an individual in a non-customer facing role might necessitate more focused work time to feel productive.

The individual is also provided a personalised score to visualize the impacts of work habits and other influences. This score is derived through a propriety algorithm. Inputs to the score include but are not limited to signals produced by and derived from interaction with workplace tools, interactions with peers and use of collaboration tools. The data considered not only looks at the individual's activity but also at that of their peers, leaders and subordinates both at a point in time and historically. These data are combined with activity, health and lifestyle data to provide a personalised and contextually relevant score.

This score is used to visualise the individuals procession or regression and to derive and affect the scoring for goals required to affect the score.

The scoring is calculated by a scoring module 36 that is typically made up of hardware and software elements and may form part of the processor 14 or may be implemented separately therefrom but connected thereto as illustrated.

Once the initial productivity profile and score algorithm have been generated, the user will interact with the program's designated mobile application, which will be powered by a proprietary software development kit (SDK). The proprietary SDK ensures that not all user data has to be consumed all the time, but rather that a subset of pertinent data signals can be consumed to drive the user's personalized program, unless batch data is required periodically for algorithm updates and program governance. The user will typically access this using their mobile telephone 24.

This SDK will consume data from various sources—including software APIs, Mobile data systems such as HealthKit and Google Fit, wearable, and cellular devices—and assess which signals are necessary to process goal recommendations and determine the attainment of the goals. In addition, the SDK will facilitate the administration of the surveys contemplated above.

The system further includes a content module 30 that generates and manages the delivery of content to system users informing them of their productivity goals as well as their score towards those goals.

If the system detects that the user is not on track to meet their goal, an appropriate communication will be generated by the content module and this will be communicated to the user.

The content module is typically made up of hardware and software elements and may form part of the processor 14 or may be implemented separately therefrom but connected thereto as illustrated.

An individual who is required to spend time in meetings throughout the day should ensure that those meetings are devoid of multi-tasking or comprised of too many unnecessary stakeholders, for example. Deviation from this prescribed course of action will lead to the generation of a goal to improve counterproductive behaviors. Goals will be generated on a periodic basis. In one example this would be from each Monday morning and will extend through Sunday evening.

Goals will be generated based on the assessment of an individual's highest risk items preventing them from maximizing their efficiency. For example, an individual who—as a function of their role—is in multiple meetings per day but spends a high proportion of that time multi-tasking might be recommended a goal on a Monday to endeavor to reduce their multi-tasking time over the course of the subsequent week. The assessment of an individual's progress towards that goal will be assessed on Sunday for example.

In another example, individuals who require substantial blocks of time devoid of distractions, in the form of meetings or e-mail correspondences, might be given a goal to block time on their calendar to ensure adequate focused work time over the course of the week, if this is a goal they are struggling to achieve. Data will be gathered from the member to assess their progress towards that goal over the course of a designated period (Monday through Sunday for example).

Goal achievement will be validated through the aforementioned verified and survey data sources. Data sourced from the variety of sources mentioned are streamed to a data lake and machine learning applied by a machine learning module 34 to train the weight of the goals proposed as well as refine the productivity score weightings.

The machine learning module combines an individual's unique organizational context, survey responses, historical goal achievement, and other data sources to ensure that the goals are likely to resonate with an individual and generate sustained behavior improvements.

More specifically, the machine learning module includes a neural network framework of machine learning algorithms that work together to classify inputs based on a previous training process. In productivity goal detection, a neural network classifies an expanded training set of inputs including an individual's unique organizational context, survey responses, historical goal achievement, and other data sources to ensure that the goals are likely to be tailored to an individual and generate sustained behavior improvements to train the neural network.

These transformations can include clustering or filtering transformations, for example, using only historic goal achievement within a certain period of time or for a specific organization. The neural networks are then trained with this expanded training set using stochastic learning with backpropagation which is a type of machine learning algorithm that uses the gradient of a mathematical loss function to adjust the weights of the network. Unfortunately, the introduction of an expanded training set increases false positives when classifying productivity goal detection.

These false positives are minimised by performing an iterative training algorithm, in which the system is retrained with an updated training set containing the false positives, produced after productivity goal detection has been performed on a set of participant's responses on whether they found a goal useful, and pairing that with their actual behavior data, an assessment can be made as to the optimal goals for various member archetypes. This combination of features provides a robust productivity goal detection model that can detect a participant's productivity goals while limiting the number of false positives.

By asking participants whether they found a goal useful, and pairing that with their actual behavior data, an assessment can be made as to the optimal goals for various member archetypes. The goals generated by the algorithm may subsequently be reweighted and prioritized based on the learnings above to maximize the program's utility to members. For instance, individual contributors in the Engineering department may typically report that goals that encourage them to block focused work time on their calendars are particularly useful, whilst goals centered around reduced multitasking in meetings are less valuable. In such cases, focus time goals will be prioritized for this cluster of individuals.

In another example, archetypes could be based on a number of corporate and behavioral traits, including but not limited to the following:
Department;
Level and seniority;
People manager responsibilities (along with team size);
The amount of time individuals spend collaborating with others versus executing well-defined tasks;
Proportion of time spent traveling for work;
Preferred and actual level of structure in one's day (e.g. individuals who have a consistent start, stop, and break times versus individuals having flexibility to structure their days as they see fit provided they meet their departmental goals);
Self-identified times of greatest productivity during the day (e.g. early morning before 9 a.m. versus early afternoon between 1 and 3 p.m.).

In this department archetypes example, each department may have a unique assessment criteria. In general, an Engineering team is expected to be task-focused, executing on well-defined work items subject to well-defined processes. By contrast, the Marketing and Sales departments would be expected to spend more time collaborating with internal and external stakeholders throughout the day, with fewer hours of focused work time. All of this is subject to individual roles and responsibilities, though for example, an Engineering manager might have a work day more akin to a Marketing professional as they are focused on oversight and team coordination rather than tasks. This is why the algorithm accounts for multiple organizational and individual aspects to ensure resonant and relevant goals.

Rewards could take any suitable form and will be framed into existing resonant incentive structures. Examples include regular micro-incentives, long-term incentives, and employer-sponsored benefits, for example the allocation of extra vacation time.

Employers are given access to aggregate and anonymized reports that illustrates potential organizational inefficiencies as well as progress made towards reducing lost productivity hours over time.

In addition to such reporting the employers will be provided with aggregated views of the score contemplated above. The aggregation will span the organisation and be segmented into logical groupings to identify cohorts that may be performing better or worse than the population.

For example, on an anonymized and aggregate basis, employers will be able to explore workplace behaviors measured as a function of integrated data and survey responses; goal attainment; and behavior improvements by department, geographic location, demographic attributes amongst other population stratifications of value to the employer. This data may be combined with other external organizational data (from human resource management software, for instance) along with organizational health and wellbeing data, providing employers with rich insights into the overall health of their organization and its people.

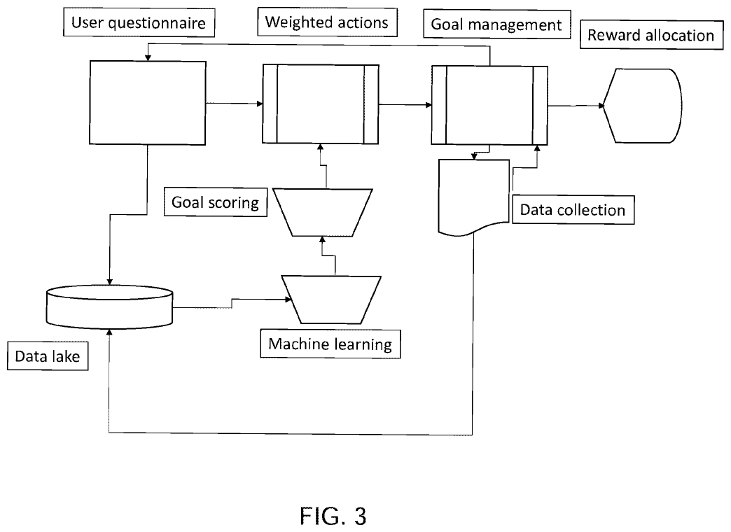

Referring to FIG. 3, a flow diagram illustrating at a high level the operation of the method implemented by the system described above is shown.

The user completes the survey questionnaire and the responses are stored in the data lake.

The unit is provided with weighted actions which are obtained by machine learning from the data lake. The machine-learning algorithm generates goal scoring from which the weighted and prioritized actions are determined.

For example, an individual's role and responsibilities will serve to personalize the goals they receive. An individual who is a people manager and is required to spend most of their day collaborating with colleagues will have their behaviors assessed against people with a similar organizational context. For example, a people manager with a role centered around collaboration might be allocated a goal of obtaining three hours of focused work time per day, whilst an individual contributor with a task-centric role might be allocated a goal of at least seven hours of focused work time per day. This ensures that the goals members receive are aspirational yet achievable.

The next phase is the user goal management and data collection around goal management.

Depending on the user's actions, the successful completion of goals will be recorded ultimately leading to a reward for the user.

In one example, the system 10 will process data from Microsoft Office 365, user surveys, and organizational data on a daily basis (or more frequently).

Based on an individual's context, an individual will receive a composite score that determines whether their behaviors are conducive to them thriving in the workplace. An individual's context might be comprised of dimensions such as people management responsibilities and whether or not they are client-facing, for example.

This score will be comprised of individual risk factors based on verified and self-reported data. If, for example, an individual's score is low due to the amount of after-hour work they conduct, a goal to remedy this will be surfaced to them.

The score is dynamic and will be refreshed on a regular basis.

1. A system for determining personalized productivity goals and monitoring workplace behaviors of an individual towards the personalized productivity goals using an AI/ML model, the system including:
a memory for storing data therein, the data including user data including a user identifier and other data relating to the user, at least one software utility account identifier each identifying a software utility account associated with the user, and at least one device identifier each identifying a device associated with the user;
a communications module for transmitting and receiving data; and
at least one processor operably coupled to the memory and the communications module, wherein the at least one processor controls the system to access the stored data and to process the data to:
retrieve the user data and use the user data to determine personalized productivity goals for the user;
receive, via the communications module, software utility account data from one or more software utility accounts associated with the user, and device data from at least one device associated with the user;
create a first training set for a first stage comprising a user's unique organizational context, a user's survey responses, a user's historical goal achievement, and other data sources;
train the AI/ML model in the first stage using the first training set for productivity goal detection;
create a second training set for a second stage comprising false positives, produced after productivity goal detection has been performed on a set of user's responses on whether a goal is useful, and pairing the user's responses with a user's actual behavior data by using the received software utility account data and device data to monitor workplace behaviors of an individual towards the personalized productivity goals; and
train the AI/ML model in the second stage using the second training set for productivity goal detection.

2. The system according to claim 1, wherein the software utility accounts include one or more of e-mail, a calendar and software collaboration tools.

3. The system according to claim 1, wherein the device associated with the user includes one or more of a laptop computer, a desktop computer, a mobile telephone, a tablet device and a wearable device.

4. The system according to claim 3, wherein the wearable device includes a heart rate monitor.

5. The system according to claim 1, wherein the received device data includes location data identifying a location of the device.

6. The system according to claim 1, wherein the received device data includes activity data including user activity on the device.

7. The system according to claim 1, wherein the received software utility account data includes data about the user's interaction with the software utilities including the user's interactions and associations with other users.

8. The system according to claim 1, wherein the system further includes a content module that generates and manages a delivery of content to system users.

9. The system according to claim 1, wherein the system further includes a survey module that generates surveys to determine productivity and workplace information.

10. The system according to claim 1, wherein the personalized productivity goals are determined by applying a goal generation algorithm to data collected for the individual.

11. The system according to claim 1, wherein the system further includes a data lake and machine learning module to determine a relationship between positive improvements in productivity measures and survey results and a broader range of data collected.

12. The system according to claim 1, wherein the system further includes a scoring module that determines and retains a history of the user's productivity score.

13. The system according to claim 1, wherein the system further wherein the communication module manages authentication between the system and external data sources.

14. A method for determining personalized productivity goals and monitoring workplace behaviors of an individual towards the personalized productivity goals using an AI/ML model, the method including:
storing data in a memory, the data including user data including a user identifier and other data relating to the user, at least one software utility account identifier each identifying a software utility account associated with the user, and at least one device identifier each identifying a device associated with the user; and
processing the data by at least one processor operably coupled to the memory to:
retrieve the user data and use the user data to determine personalized productivity goals for the user;
receive, via a communications module, software utility account data from one or more software utility accounts associated with the user, and device data from at least one device associated with the user;
create a first training set for a first stage comprising a user's unique organizational context, a user's survey responses, a user's historical goal achievement, and other data sources;
train the AI/ML model in the first stage using the first training set for productivity goal detection;
create a second training set for a second stage comprising false positives, produced after productivity goal detection has been performed on a set of user's responses on whether a goal is useful, and pairing the user's responses with a user's actual behavior data by using the received software utility account data and device data to monitor workplace behaviors of an individual towards the personalized productivity goals; and
train the AI/ML model in the second stage using the second training set for productivity goal detection.

15. The method according to claim 14, wherein the software utility accounts include one or more of e-mail, a calendar and software collaboration tools.

16. The method according to claim 14, wherein the device associated with the user includes one or more of a laptop computer, a desktop computer, a mobile telephone, a tablet device and a wearable device.

17. The method according to claim 16, wherein the wearable device includes a heart rate monitor.

18. The method according to claim 14, wherein the received device data includes location data identifying a location of the device.

19. The method according to claim 14, wherein the received device data includes activity data including user activity on the device.

20. The method according to claim 14, wherein the received software utility account data includes data about the user's interaction with the software utilities including the user's interactions and associations with other users.

21. The method according to claim 14, wherein the personalized productivity goals are determined by applying a goal generation algorithm to data collected for the individual.

22. The method according to claim 14, wherein the user is rewarded for a successful completion of goals.
